(19) United States
(12) Patent Application Publication
(10) Pub. No.: US 2025/0376268 A1
(43) Pub. Date: Dec. 11, 2025

(54) Method for facilitating the landing of an aircraft, related computer program and electronic device

(71) Applicant: THALES, Meudon (FR)

(72) Inventors: Audrey AUBIGNAC, MERIGNAC (FR); Pierre-Jean AUILLANS, MERIGNAC (FR); Mohamed TAHIRI, MERIGNAC (FR); Siegfried ROUZES, MERIGNAC (FR)

(21) Appl. No.: 19/216,706

(22) Filed: May 23, 2025

(30) Foreign Application Priority Data
May 31, 2024 (FR) 2405705

(51) Int. Cl. B64D 45/04; G08G 5/54

(52) U.S. Cl. CPC B64D 45/04; G08G 5/54

(57) ABSTRACT

A method of facilitating the landing of a civil aircraft on a potential landing zone divided into sub-zones. The method includes a step of producing a digital surface model of the potential landing zone using topographic terrain data. In a placement step, the digital surface model is positioned and/or orientated in space to obtain a placed digital surface model. In a calculation step, an overall risk level is calculated for each sub-zone on the basis of the placed digital surface model and characteristics of the sub-zone including topography, accessibility, loss of visibility, and presence of living beings. A reporting step comprises generating an information signal dependent on the overall risk levels, and/or transmitting a control signal dependent on the overall risk levels.

### REFERENCE TO RELATED APPLICATION

This application is a U.S. non-provisional application claiming the benefit of French Patent Application No. 24 05705 filed on May 31, 2024, the contents of which are incorporated herein by reference in their entirety.

### TECHNICAL FIELD OF THE INVENTION

The present invention relates to a method for facilitating the landing of a civil aircraft on a potential landing zone, implemented by an electronic landing assistance device intended to be carried on board the civil aircraft.

The present invention further relates to a non-transitory computer-readable medium including a computer program including software instructions which, when executed by a computer, implement such a method. It also relates to such an electronic device for assisting the landing of a civil aircraft on a potential landing zone.

The invention relates to the field of landing aids for civil aircraft on unprepared terrain. When landing on unprepared terrain, the pilot of a civil aircraft, such as a helicopter or airplane, generally applies a decision-making process for approaches and take-offs (abbreviated MRAD in French). To do this, he has to analyze his environment to determine the precise point where he is going to land the aircraft, the axis of approach given the wind and obstacles, and the type of approach he is going to use. This complex analysis involves a significant cognitive workload for the pilot, as well as being dependent on weather conditions that can impair visibility. This creates a high level of uncertainty associated with the risk of an accident on landing, which could result in material and/or human losses.

### BACKGROUND OF THE INVENTION

To help the pilot during this landing phase in unprepared terrain, U.S. Pat. No. 8,521,343 B2 describes a self-piloting system that determines an optimum landing trajectory, taking into account the profile of the terrain and any obstacles.

However, this system only takes into account a limited number of parameters and does not reflect the complexity of the terrain analysis carried out by an experienced pilot. What's more, this solution requires the use of a predefined database.

### SUMMARY OF THE INVENTION

The aim of the invention is therefore to propose a method for facilitating the landing of an aircraft, making it possible to help a pilot land the aircraft in unprepared terrain, while limiting the risk of an accident.

To this end, the object of the invention is a method of facilitating the landing of a civil aircraft on a potential landing zone, implemented by an electronic landing assistance device intended to be carried on board the aircraft, the potential landing zone being divided into sub-zones, the method including:
a step of producing a digital surface model of the potential landing zone using topographic terrain data;
a step of placing the digital surface model, during which the digital surface model is positioned and/or orientated in space using aircraft attitude and/or positioning data, in order to obtain a placed digital surface model;
a step of calculating risk level, during which an overall risk level is calculated for each sub-zone on the basis of at least the placed digital surface model and taking into account at least two characteristics of the sub-zone from among a topographical characterization, an accessibility characterization, a loss of visibility characterization and a living being presence characterization; and
a step of reporting risk level, including the implementation of at least one action from the group consisting of: generating, for at least one operator of the aircraft, an information signal dependent on the overall risk levels; and transmitting, to at least one avionics system, a control signal dependent on the overall risk levels.

Thanks to the invention, the decision to carry out an unprepared landing on a given terrain and the choice of landing point are significantly facilitated by the reporting of the risk level, the risk level taking into account various parameters which no longer have to be analyzed by sight by the pilot, which significantly reduces the cognitive load of the pilot in the critical phase, and consequently reduces the risk of accident.

In other beneficial aspects of the invention, the method includes one or more of the following features, taken in isolation or in any technically possible combination:
the step of calculating risk level includes, for each sub-zone, a sub-step of determining at least one individual risk level for each respective characterization, then a sub-step of calculating the overall risk level from the individual risk levels associated with the different characterizations.
the reporting step includes implementing at least one action from the group consisting of: generating, for at least one aircraft operator, a secondary information signal dependent on at least one individual risk level; and transmitting, to at least one avionics system, a secondary control signal dependent on at least one individual risk level.
the method further includes a step of acquiring at least one terrain characteristic from a sensor, during which at least one terrain characteristic is acquired from the sensor and positioned and/or orientated in space using attitude and/or positioning data of the aircraft in order to obtain a respective placed terrain characteristic, and the overall risk level is calculated from the placed digital surface model and the at least one placed terrain characteristic; each terrain characteristic being selected from the group including: a color characteristic of the sub-zone, a thermal characteristic of the sub-zone, a radar reflectivity of the sub-zone, and a movement characteristic of at least one obstacle on the surface of the sub-zone.
the at least one terrain characteristic is selected from the group consisting of the color characteristic of the sub-zone, the thermal characteristic of the sub-zone and the radar reflectivity of the sub-zone; and the visibility loss characterization includes a ground classification performed from the at least one terrain characteristic, the at least one individual risk level associated with the visibility loss characterization being increased if the ground classification corresponds to ground likely to generate a loss of visibility.
the at least one terrain characteristic is selected from the group including the thermal characteristic of the sub-zone and the movement characteristic of obstacle(s) in the sub-zone; and the at least one individual risk level associated with the living being presence characterization is higher if the at least one terrain characteristic corresponds to a thermal or dynamic signature of a living being, and lower if it does not.
the characterization of the topography of the sub-zone includes at least one characterization parameter from the group including:
   a standard deviation of elevation data from an average plane of the sub-zone, the at least one individual risk level associated with the topography characterization being greater when the standard deviation is higher; and
   a slope value, the at least one individual risk level associated with the topography characterization being greater when the standard deviation is higher.
the characterization of the accessibility of the sub-zone includes at least one characterization parameter from the group including:
   a value of the area of accessible terrain including the sub-zone, the at least one individual risk level associated with the accessibility characterization being greater when the area of accessible terrain is smaller;
   the presence or absence of at least one accessible path of a predetermined minimum length including the sub-zone and an angle of incidence for landing along the at least one accessible path, the at least one individual risk level associated with the accessibility characterization being at its highest in the absence of the at least one accessible path, and lower when the angle of incidence in the presence of the at least one accessible path is smaller;
   the presence or absence of the at least one accessible path and a width of the at least one accessible path, the at least one individual risk level associated with the accessibility characterization being at its highest in the absence of the at least one accessible path, and lower when the angle of incidence in the presence of the at least one accessible path is wider; and
   an angle between a plane of the terrain at a landing point and a line connecting the landing point to a highest obstacle at a predetermined maximum distance from the landing point, the at least one individual risk level associated with the accessibility characterization being higher when the angle is greater.

The invention further relates to a non-transitory computer-readable medium including a computer program including software instructions, which, when carried out by a computer, implement a method as defined above.

The invention further relates to an electronic device for assisting the landing of an aircraft on a potential landing zone, the potential landing zone being divided into sub-zones, the device including:
a production module configured to produce a digital surface model of the potential landing zone using topographic terrain data;
a placement module, configured to position and orientate the digital surface model in space using aircraft attitude and/or positioning data, to obtain a placed digital surface model;
a calculation module configured to calculate an overall risk level for each sub-zone on the basis of at least the placed digital surface model and taking into account at least two characteristics of the sub-zone from among a topographical characterization, an accessibility characterization, a loss of visibility characterization and a living being presence characterization; and
a reporting module configured to report the overall risk levels by implementing at least one action from the group consisting of: generating, for at least one operator of the aircraft, an information signal dependent on the overall risk levels; and transmitting, to at least one avionics system, a control signal dependent on the overall risk levels.

### BRIEF DESCRIPTION OF THE DRAWINGS

The invention will appear more clearly when reading the description that follows, given solely as a non-limiting example and made in reference to drawings in which:

FIG. 1 is a schematic view of a civil aircraft including a landing assistance device according to the invention;

FIG. 2 is a flow chart of a landing assistance method according to the invention, the method being implemented by the landing assistance method of FIG. 1; and

FIG. 3 is an example of a screen implementing a risk level reporting step according to the invention.

### DETAILED DESCRIPTION OF THE INVENTION

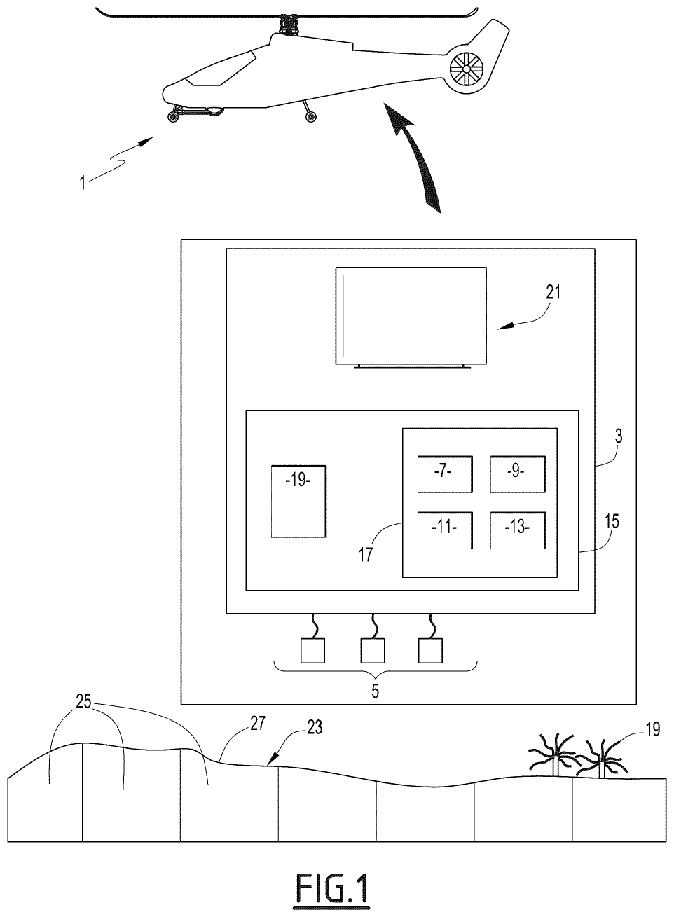

In FIG. 1, a civil aircraft 1 includes a landing assistance device 3 and sensors 5, intended to be carried on board the civil aircraft 1.

The civil aircraft 1 is in particular a rotary-wing aircraft, such as a civil helicopter, as shown in FIG. 1. Alternatively, the civil aircraft 1 is an airliner or a civil drone, which may or may not be piloted remotely by a remote operator.

The civil aircraft 1 is operated by an operator, typically a pilot.

The electronic landing assistance device 3 includes a production module 7, a placement module 9, a computing module 11 and a reporting module 13.

The production module 7 is configured to produce a digital surface model M of the potential landing zone 23 using topographic terrain data D1.

The placement module 9 is configured to position and orientate the digital surface model M in space using aircraft 1 attitude and/or positioning data, to obtain a placed digital surface model M′.

The calculation module 11 is configured to calculate an overall risk level for each sub-zone 25 on the basis of at least the placed digital surface model M′ and taking into account at least two characteristics of the sub-zone from among a topographical characterization, an accessibility characterization, a loss of visibility characterization and a living being presence characterization.

The reporting module 13 is configured to report the overall risk levels R by implementing at least one action from the group consisting of: generating, for at least one operator of the aircraft 1, an information signal dependent on the overall risk levels R; and transmitting, to at least one avionics system, a control signal dependent on the overall risk levels R.

Details of the operations carried out by each of these modules 7, 9, 11 and 13 are described later in the description, in particular when describing the steps of the landing assistance method according to the invention.

In the example shown in FIG. 1, the electronic processing device 3 includes an information processing unit 15 formed for example by a memory 17 and a processor 19 associated with the memory 17.

In the example of FIG. 1, the production module 7, the placement module 9, the calculation module 11, and the reporting module 13 are each in the form of software or a software brick, which may be executed by the processor 19. The memory 17 of the electronic landing assistance device 3 is then able to store production software, placement software, calculation software, and reporting software. The processor 19 is then able to execute each one of the production software, placement software, calculation software, and reporting software.

In a variant not shown, the production module 7, the placement module 9, the calculation module 11, and the reporting module 13 are each in the form of a programmable logical component, such as a FPGA (Field Programmable Gate Array), or as a dedicated integrated circuit, such as an ASIC (Application-Specific Integrated Circuit).

When the electronic landing assistance device 3 is in the form of one or more software, that is to say in the form of a computer program, it is also capable of being stored on a computer-readable medium, not shown. The computer-readable medium is, for example, a medium that may store electronic instructions and be coupled with a bus from a computer system. For example, the readable medium is an optical disk, magneto-optical disk, ROM memory, RAM memory, any type of non-volatile memory (for example EPROM, EEPROM, FLASH, NVRAM), magnetic card or optical card. The readable medium in such a case stores a computer program including software instructions.

The electronic landing assistance device 3 further includes a reporting apparatus 21. In the example shown in FIG. 1, the reporting apparatus 21 is a human-machine interface and typically includes a screen. Alternatively, and not shown here, the human-machine interface may include an indicator light, a speaker, or a haptic interface. According to another variant, the reporting device 13 may be an interface for connection to one or more avionics systems not shown.

The sensors 5 are connected to the electronic landing assistance device 3 via a wired or wireless link. Advantageously, the sensors 5 include primary sensors, capable of acquiring topographic terrain data D1, and secondary sensors, capable of acquiring terrain characteristics D2, distinct from the topographic terrain data D1.

The primary sensors include cameras in the visible range, radar, and lidar.

The secondary sensors include infrared cameras or motion sensors.

In a variant not shown, other sensors, not fitted to the civil aircraft 1 but fitted to another aircraft or to a satellite and also providing topographical terrain data or terrain characteristics, are also connected to the electronic landing assistance device 3.

During a mission, the civil aircraft 1 may have to land on unprepared terrain. The unprepared terrain on which the aircraft is likely to land, known as the potential landing zone 23 and shown in FIG. 1, is divided into sub-zones 25. The potential landing zone 23 may include characteristics likely to cause an accident during landing, for example reliefs 27, obstacles 29, or a type of terrain, for example sandy, likely to generate a loss of visibility during landing (brown-out, white-out).

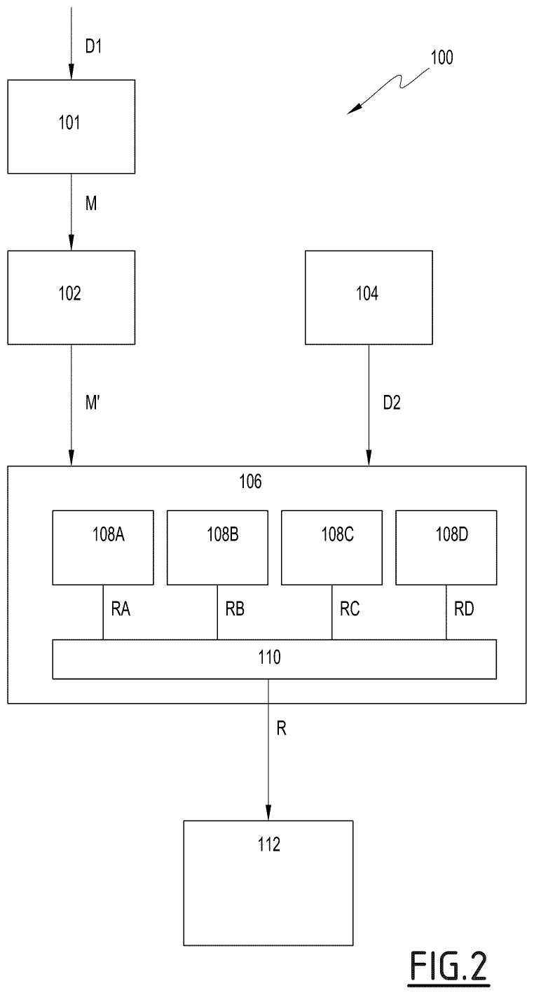

A landing assistance method 100, designed to help the pilot of the aircraft 1 or an autonomous system make a safe landing in the potential landing zone 23, is then implemented by the electronic landing assistance device 3. In particular, this method includes determining a landing accident risk level for each sub-zone 25 of the potential landing zone 23, enabling the pilot or the autonomous system to be guided in choosing the sub-zone 25 in which to land the aircraft 1. This method is described below with reference to FIG. 2.

During a first step 101 of producing a digital surface model, implemented by the production module 7, the topographic terrain data D1 from the primary sensors is used to produce a digital surface model M of the potential landing zone 23.

This digital surface model M is advantageously produced by photogrammetry. Photogrammetry is a technique that involves capturing images to determine the position, size and volume in space of a subject, in this case the potential landing zone 23, as well as its characteristics. The digital surface model M is a three-dimensional representation of a topographical profile of the potential landing zone 23, as well as all the elements present in this zone, such as buildings or vegetation.

During a step 102 of placing the digital surface model, implemented by the placement module 9, the digital surface model M is positioned in space by georeferencing the topographic terrain data D1. On-board edge computing capabilities, for example, enable these calculations to be carried out in real time. This placement step 102 provides a placed digital surface model M′.

Advantageously, as an optional complement, the landing assistance method 100 further includes a step 104 of acquiring terrain characteristics, during which at least one terrain characteristic is acquired from a respective sensor, then positioned and/or orientated in space with the assistance of attitude and/or positioning data of the aircraft in order to obtain a respective placed terrain characteristic D2. The placed terrain characteristics D2 preferably include a color characteristic, a thermal characteristic, a radar reflectivity, and a movement characteristic of at least one obstacle.

In a variant not shown, the terrain characteristics acquired during the terrain characteristic acquisition step 104 are positioned and/or orientated in space at the same time as the digital surface model M during the digital surface model placement step 102. The person skilled in the art will understand that this variant corresponds to the case where the terrain characteristics are acquired before the placement step 102, then merged with the digital surface model M produced during the production step 101 to form an enriched model, the enriched model then being positioned in space during the placement step 102 to obtain the placed digital surface model M′ with the addition of the placed terrain characteristics D2, also known as the enriched placed digital surface model.

The placed digital surface model M′ and the placed terrain characteristics D2 are then used in a risk level calculation step 106, implemented by the calculation module 11. During this calculation step 106, an overall risk level R is calculated for each sub-zone 25, taking into account at least two characterizations of the sub-zone 25 from among a topographical characterization, an accessibility characterization, a loss of visibility characterization, and a living being presence characterization.

Alternatively, the risk level calculation step 106 also uses data from one or more databases.

The overall risk level R is expressed, for example, as a percentage, with a value of 0% corresponding to the riskiest conditions, i.e., a maximum risk level, and a value of 100% corresponding to the least risky conditions, i.e., a minimum risk level. In other words, a high risk level corresponds to a percentage close to 0, while a low risk level corresponds to a percentage close to 100. An “increase in the risk level” therefore means a reduction in the percentage. Conversely, a “decrease in the risk level” means an increase in the percentage.

Advantageously, the risk level calculation step 106 is broken down into a sub-step 108A, 108B, 108C or 108D of calculating the individual risk level RA, RB, RC or RD for each of the aforementioned characterizations, and a sub-step 110 of calculating the overall risk level R from the individual risk levels RA, RB, RC and RD.

There may be four risk level calculation sub-steps 108A-D, as in the example shown in FIG. 2, or more generally a number equal to the number of distinct characterizations used.

The individual risk levels RA, RB, RC and RD are, for example, expressed in the same form as the overall risk level R. Each risk level RA, RB, RC or RD corresponds to an individual risk level associated with the characterization or to the multiplication of different individual risk levels associated with the same characterization.

In a variant not shown, the same sub-step 108A, 108B, 108C and/or 108D of calculating the individual risk level provides several individual risk levels associated with the characterization in question.

Advantageously, the overall risk level R is the result of multiplying the individual risk levels RA, RB, RC and RD. So, if one of the criteria gives a maximum risk level (value of the risk level equal to 0%), then the overall risk level R is also maximum (value of the risk level also equal to 0%).

The content of sub-steps 108A, 108B, 108C and 108D is described in detail below. Any numerical criteria given in these explanations are given by way of example only and may advantageously be adjusted in the electronic landing assistance device 3 according to the specific needs of each user. In addition, various characterization parameters are explained in this section, and may be combined in all technically possible ways to form different embodiments of the invention.

The first sub-step 108A for calculating the individual risk level corresponds, for example, to characterizing the topography of the sub-zone 25.

A first individual risk level RA associated with the topography characterization corresponds, for example, to a slope in the sub-zone 25. The higher the value of the slope in the sub-zone 25, the higher the individual risk level. For example, the value of the individual risk level is 0% if the value of the slope exceeds a predetermined threshold, 100% if the value of the slope is 0°, and its evolution as a function of the value of the slope between these two extremes follows a predetermined law, for example a linear or logarithmic law. The value of the predetermined threshold is typically taken from charts supplied by the manufacturer of the aircraft 1, and is, for example, on the order of 12°.

A second individual risk level RA associated with the topography characterization corresponds, for example, to the flatness of the sub-zone 25 and involves a standard deviation of elevation data with respect to an average plane of the sub-zone 25. The average plane is advantageously obtained by linear regression on a set of elevation data obtained by radar in sub-zone 25 or over a given surface, for example in such a way as to minimize the sum of the squares of the distances of each item of elevation data from the average plane. In other words, a least-squares regression is typically performed on this set of three-dimensional elevation data to obtain the average plane, this regression then allowing the average plane to be passed into this set of three-dimensional points, using the least-squares method. The surface is, for example, a square with a length equal to a length of the aircraft 1 and may be extended by adding neighboring surfaces if a slope of the average plane of the neighboring surface is similar to a slope of the average plane of the surface under consideration, for example if the difference in slope is less than 1°, and if the standard deviation of the elevation data relative to the average plane of the neighboring surface is similar to the standard deviation of the elevation data relative to the average plane of the surface under consideration, for example if the difference in standard deviation is less than 5 cm. The higher the standard deviation, the higher the individual risk level. For example, the value of the individual risk level is 0% for a standard deviation greater than 50 cm, and 100% for a standard deviation less than 5 cm, and its change as a function of the standard deviation between these two extremes follows a predetermined law, for example a linear or logarithmic law.

The second sub-step 108B for calculating the individual risk level corresponds, for example, to characterizing the accessibility of the sub-zone 25.

A first individual risk level RB associated with the accessibility characterization involves, for example, a value of an area of accessible terrain including the sub-zone 25. The smaller the area of accessible terrain, the higher the individual risk level. The area of accessible terrain is advantageously defined as the area of the largest terrain including the sub-zone and not including any obstacle of a size greater than or equal to 50 cm relative to the average plane of the sub-zone in which the obstacle is located. For example, the value of the individual risk level is 0% if a diameter of the largest circle contained in the accessible terrain area is less than or equal to a maximum length of the aircraft 1, 100% if this diameter is greater than three times the maximum length of the aircraft 1, and the change in this individual risk level as a function of the diameter between these two extremes follows a predetermined law, for example a linear or logarithmic law.

A second and third individual risk level RB associated with the accessibility characterization depend, for example, on the presence or absence of at least one accessible path of a predetermined minimum length including the sub-zone 25. Preferably, the second and third individual risk levels RB associated with the accessibility characterization depend more preciously on the presence or absence of two accessible paths of the predetermined minimum length that are substantially perpendicular to each other. The predetermined minimum length is on the order of 200 m, for example.

The second individual risk level RB associated with the accessibility characterization also depends on an angle of incidence for landing along the at least one accessible path, if there is one. This level of individual risk is highest in the absence of at least one such accessible path, and lower when the angle of incidence is lower in the presence of at least one such accessible path. For example, the value of the risk level is 0% when there is no accessible path or for an angle of incidence greater than 90°, 100% when there is an accessible path and for an angle of incidence equal to 0°, and the change in this individual risk level as a function of the angle of incidence between these two extremes in the presence of an accessible path follows a predetermined law, for example a linear or logarithmic law.

The third individual risk level RB associated with the accessibility characterization also depends on a width of the at least one accessible path, if there is one. This level of individual risk is highest in the absence of such an accessible path, and lower when the width is greater in the presence of at least one such accessible path. For example, the value of the risk level is 0% in the absence of an accessible path or for an accessible path width of less than 1.5 times the rotor diameter of the aircraft 1, 100% in the presence of an accessible path and for an accessible path width of more than 5 times the rotor diameter of the aircraft 1, and the change in this individual risk level as a function of the width of the path between these two extremes in the presence of an accessible path follows a predetermined law, for example a linear or logarithmic law.

A fourth individual risk level RB associated with the accessibility characterization depends, for example, on an angle between a plane of the terrain at a landing point and a line connecting the landing point to a highest obstacle at a predetermined maximum distance from the landing point. The greater the angle, the greater the individual risk level. For example, the value of the individual risk level is 0% if the angle is greater than 30°, 100% if the angle is 0°, and its change as a function of the angle between these two extremes follows a predetermined law, for example a linear or logarithmic law.

The third sub-step 108A for calculating the individual risk level corresponds, for example, to characterizing the loss of visibility of the sub-zone 25.

An individual risk level RC associated with the loss of visibility characterization involves, for example, a color characteristic of the sub-zone 25, a thermal characteristic of the sub-zone 25, and a radar reflectivity of the sub-zone 25. This individual risk level defaults to a value of 100% (minimum risk) and is increased, by decreasing the percentage, if the ground classification corresponds to a ground likely to generate a loss of visibility. Advantageously, this classification is carried out using a combination of placed terrain characteristics and the placed digital surface model. According to a first example, the increase in the risk level is determined by a machine learning algorithm taking as input the placed terrain characteristics and the placed digital surface model, combined into the enriched digital surface model. In a second example, the risk level is increased according to the nature of the ground based on a predetermined database of different ground types. For example, a yellow/beige-colored ground is identified as sand or dust and gives an individual risk level of 50% due to the risk of brown-out. A white-colored ground and a temperature below 5° C. is identified as ice and gives an individual risk level of 50%. A ground with several layers perceived by the radar with a differential of between 10 cm and 20 cm between each layer gives an individual risk of 50%, the same ground with a differential of more than 50 cm between the layers gives an individual risk of 0%; and a change in the individual risk as a function of the differential between these two extremes follows a predetermined law, for example a linear law. Very flat ground with little echo and a blue color is identified as a body of liquid water and gives an individual risk level of 0%.

The fourth sub-step 108D for calculating the individual risk level corresponds, for example, to characterizing the presence of a living being in the sub-zone 25.

A individual risk level RD associated with the characterization of the presence of a living being involves, for example, a thermal characteristic of the sub-zone 25 and a characteristic of movement of obstacle(s) of the sub-zone 25. This individual risk level is all the greater because the terrain characteristics correspond to the thermal and dynamic signature of a living being. For example, a mobile object with a volume of more than 20 liters gives an individual risk level of 25% if the temperature is between 35 and 40 degrees and 50% otherwise. The presence of at least two moving objects, each with a volume greater than 20 liters, gives a risk level of 0%.

The sub-step 110 of calculating the overall risk level R from the individual risk levels RA, RB, RC and RD involves, for example, multiplying the individual risk levels RA, RB, RC and RD. Thus, if only one of the risk levels is zero (corresponding to the riskiest conditions), then the overall risk level is also zero.

Alternatively, the sub-steps 108A, 108B, 108C and 108D for calculating the individual risk level, as well as the sub-step 110 for calculating the overall risk level, are performed by an automatic learning algorithm taking as input the placed terrain characteristics D2 and the placed digital surface model M′. For the sub-step 110 of calculating the overall risk level, machine learning is used to determine a model for calculating the overall score with optimal weights associated with each of the individual risk levels.

Alternatively, machine learning is used only for steps 108A, 108B, 108C and 108D for calculating the individual risk level.

According to another variant, the step 106 of calculating the overall risk level is performed by a machine learning algorithm taking as input the placed terrain characteristics and the placed digital surface model, without calculating the individual risk levels RA, RB, RC and RD.

The landing assistance method 100 includes a step 112 of reporting the risk level, implemented by the reporting module 13 to the reporting apparatus 21. During this reporting step 112, a signal dependent on the overall risk level R of each sub-zone 23 is generated by the reporting module 21.

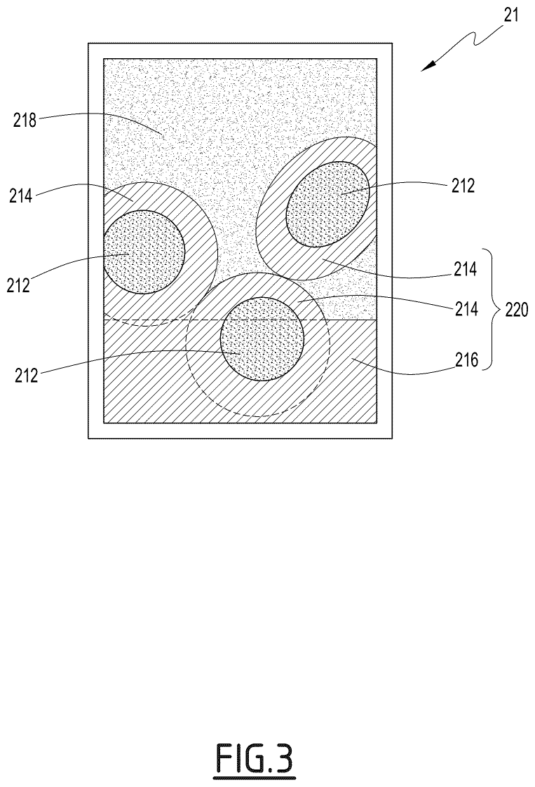

According to a first exemplary embodiment, the signal is an information signal to inform an aircraft operator. FIG. 3 shows an example of an information signal in the form of a mapping image of the potential landing zone, in which each sub-zone is colored according to its overall risk level. In the example shown in FIG. 3, the zone 212 is a high-risk zone (overall risk level R between 0% and 33%) due to the proximity of an obstacle. The dark, triangle-based fill of the high-risk zone 212 in FIG. 3 corresponds, for example, to a red display. The zone 220 is a medium-risk zone (overall risk level R of between 34% and 66%). The striped fill of the medium-risk zone 220 corresponds, for example, to a yellow display. In the example shown in FIG. 3, the medium-risk zone 220 results from combining medium-risk zones 214 whose risk is due to the average distance to an obstacle and a medium-risk zone 216 whose risk is due to the disadvantageous topography of the terrain. The zone 218 is a low-risk zone (overall risk level R of between 67% and 100%). The dotted-line fill of the low-risk zone 218 corresponds, for example, to a green display.

Alternatively, the information signal may be an audible signal, a warning light, or haptic feedback (such as a vibration of a component of the aircraft) depending on the risk level of the sub-zone 23 over which the aircraft 1 is flying at a given moment in time.

According to a second example, the signal is a control signal for an avionics system, enabling the aircraft 1 to carry out all or part of the landing 1 autonomously, without the intervention of an operator. For example, the control signal may be sent to an automatic landing system to indicate the sub-zone 25 with the lowest risk level closest to it.

Advantageously, in the two examples given above, the reporting module 21 also generates a secondary signal, depending on at least one of the individual risk levels RA, RB, RC and/or RD. For example, a secondary information signal intended for an aircraft operator is an image of a map similar to FIG. 3 reporting only the individual risk level associated with the topography of the sub-zone. This mapping may be accessed via a menu, for example, enabling the operator to select the information to be displayed.

In all cases, the information or command thus provided helps the pilot or the control system to carry out an unprepared landing of the aircraft 1, thereby reducing the risk of an accident.

Each characteristic described above for one of the exemplary embodiments or a variant may be implemented in the other exemplary embodiments and variants described above, insofar as this is technically possible.

1. A method for facilitating landing a civil aircraft on a potential landing zone, implemented by an electronic landing assistance device carried on board the aircraft, the potential landing zone being divided into sub-zones, the method comprising:
producing a digital surface model of the potential landing zone using topographic terrain data;
positioning and/or orienting the digital surface model in space using aircraft attitude and/or positioning data, in order to obtain a placed digital surface model;
calculating an overall risk level for each sub-zone on the basis of at least the placed digital surface model and taking into account at least two characteristics of the sub-zone from among a topographical characterization, an accessibility characterization, a loss of visibility characterization, and a living being presence characterization, the calculating comprising:
determining, for each sub-zone, at least one individual risk level for each respective characterization; and
calculating the overall risk level from the individual risk levels associated with the various characterizations,
wherein the topographical characterization of the sub-zone comprises (i) a standard deviation of elevation data with respect to an average plane of the sub-zone, the at least one individual risk level associated with the topography characterization being greater when the standard deviation is higher, and/or (ii) a slope value, the at least one individual risk level associated with the topography characterization being greater when the slope is higher; and
reporting risk level, comprising (i) generating, for at least one operator of the aircraft, an information signal dependent on the overall risk levels, and/or (ii) transmitting, to at least one avionics system, a control signal dependent on the overall risk levels.

2. The method according to claim 1, wherein said reporting comprises (i) generating, for at least one aircraft operator, a secondary information signal dependent on at least one individual risk level, and/or (ii) transmitting, to at least one avionics system, a secondary control signal dependent on at least one individual risk level.

3. The method according to claim 1, further comprising acquiring at least one terrain characteristic from a sensor, during which the at least one terrain characteristic is positioned and/or orientated in space using attitude and/or positioning data of the aircraft in order to obtain a respective placed terrain characteristic, and wherein the overall risk level is calculated from the placed digital surface model and the at least one placed terrain characteristic, each terrain characteristic being selected from the group consisting of a color characteristic of the sub-zone, a thermal characteristic of the sub-zone, a radar reflectivity of the sub-zone, and a movement characteristic of at least one obstacle on the surface of the sub-zone.

4. The method according to claim 3, wherein the at least one terrain characteristic is selected from the group consisting of the color characteristic of the sub-zone, the thermal characteristic of the sub-zone, and the radar reflectivity of the sub-zone, and wherein the visibility loss characterization comprises a ground classification performed from the at least one terrain characteristic, the at least one individual risk level associated with the visibility loss characterization being increased if the ground classification corresponds to ground likely to generate a loss of visibility.

5. The method according to claim 3, wherein the at least one terrain characteristic is selected from the group comprising the thermal characteristic of the sub-zone and the movement characteristic of obstacle(s) in the sub-zone, and the at least one individual risk level associated with the living being presence characterization is higher if the at least one terrain characteristic corresponds to a thermal or dynamic signature of a living being, and lower if it does not.

6. The method according to claim 1, wherein the accessibility characterization of the sub-zone comprises at least one characterization parameter from the group consisting of (i) a value of the area of accessible terrain including the sub-zone, the at least one individual risk level associated with the accessibility characterization being greater when the area of accessible terrain is smaller, (ii) the presence or absence of at least one accessible path of a predetermined minimum length including the sub-zone and an angle of incidence for landing along the at least one accessible path, the at least one individual risk level associated with the accessibility characterization being at its highest in the absence of the at least one accessible path, and lower when the angle of incidence in the presence of the at least one accessible path is smaller, (iii) the presence or absence of the at least one accessible path and a width of the at least one accessible path, the at least one individual risk level associated with the accessibility characterization being at its highest in the absence of the at least one accessible path, and lower when the angle of incidence, in the presence of the at least one accessible path, is wider, and (iv) an angle between a plane of the terrain at a landing point and a line connecting the landing point to a highest obstacle at a predetermined maximum distance from the landing point, the at least one individual risk level associated with the accessibility characterization being higher when the angle is greater.

7. A non-transitory computer-readable medium including a computer program comprising software instructions which, when executed by a computer, implement a method according to claim 1.

8. An electronic device for assisting landing an aircraft on a potential landing zone, the potential landing zone being divided into sub-zones, the device comprising:
a model producer producing a digital surface model of the potential landing zone using topographic terrain data;
a model positioner positioning and orientating the digital surface model in space using aircraft attitude and/or positioning data, to obtain a placed digital surface model;
a risk calculator calculating an overall risk level for each sub-zone on the basis of at least the placed digital surface model and taking into account at least two characteristics of the sub-zone from among a topographical characterization, an accessibility characterization, a loss of visibility characterization and a living being presence characterization, wherein the calculator determines, for each sub-zone, at least one individual risk level for each respective characterization, and then calculates the overall risk level from the individual risk levels associated with the different characterizations, and wherein the characterization of the topography of the sub-zone comprises (i) a standard deviation of elevation data with respect to an average plane of the sub-zone, the at least one individual risk level associated with the topography characterization being greater when the standard deviation is higher, and/or (ii) a slope value, the at least one individual risk level associated with the topography characterization being greater when the slope is higher; and
a risk reporter reporting the overall risk levels by (i) generating, for at least one operator of the aircraft, an information signal dependent on the overall risk levels, and/or (ii) transmitting, to at least one avionics system, a control signal dependent on the overall risk levels.
